(19) United States
(12) Patent Application Publication
(10) Pub. No.: US 2012/0229859 A1
(43) Pub. Date: Sep. 13, 2012

(54) PATTERN GENERATING APPARATUS, IMAGE FORMING APPARATUS, AND NON-TRANSITORY COMPUTER READABLE MEDIUM STORING PROGRAM

(75) Inventor: Masaki KYOJIMA, Kanagawa (JP)

(73) Assignee: FUJI XEROX CO., LTD., Tokyo (JP)

(21) Appl. No.: 13/214,926

(22) Filed: Aug. 22, 2011

(30) Foreign Application Priority Data
Mar. 10, 2011 (JP) 2011-052533

(51) Int. Cl. G06K 15/02

(52) U.S. Cl. 358/1.18

(57) ABSTRACT

A pattern generating apparatus includes a setting unit, an identifying unit, and a generating unit. The setting unit sets a pattern area on a recording medium. The identifying unit identifies a position of the pattern area, which is arranged in a plane having a predetermined size with a specified position in the pattern area located at or substantially at a center of the plane, in the plane. The generating unit generates a pattern into which the identified position is coded.

### CROSS-REFERENCE TO RELATED APPLICATIONS

This application is based on and claims priority under 35 USC 119 from Japanese Patent Application No. 2011-052533 filed Mar. 10, 2011.

### BACKGROUND

(i) Technical Field

The present invention relates to a pattern generating apparatus, an image forming apparatus, and a non-transitory computer readable medium storing a program.

(ii) Related Art

Techniques for digitalizing characters and figures that are handwritten on paper with digital pens are known. The digital pens read special patterns formed on the paper to record tracks of the handwritten characters and figures.

### SUMMARY

According to an aspect of the invention, there is provided a pattern generating apparatus including a setting unit, an identifying unit, and a generating unit. The setting unit sets a pattern area on a recording medium. The identifying unit identifies a position of the pattern area, which is arranged in a plane having a predetermined size with a specified position in the pattern area located at or substantially at a center of the plane, in the plane. The generating unit generates a pattern into which the identified position is coded.

### BRIEF DESCRIPTION OF THE DRAWINGS

Exemplary embodiment(s) of the present invention will be described in detail based on the following figures, wherein:

FIG. 1 is a diagram illustrating a configuration of an image forming system;

FIG. 2 is a diagram illustrating an example of a pattern;

FIG. 3 is a diagram illustrating a functional configuration of a controller;

FIG. 4 is a diagram illustrating an example of an image;

FIG. 5 is a flowchart illustrating a process performed by the controller;

FIG. 6 is a diagram illustrating an example of a pattern area;

FIG. 7 is a diagram illustrating an example of a pattern area;

FIG. 8 is a diagram describing a method for identifying coordinates;

FIG. 9 is a diagram illustrating an example of a combined image;

FIG. 10 is a diagram illustrating an example of a pattern area according to a modification; and

FIG. 11 is a diagram illustrating an example of a pattern area according to a modification.

### DETAILED DESCRIPTION

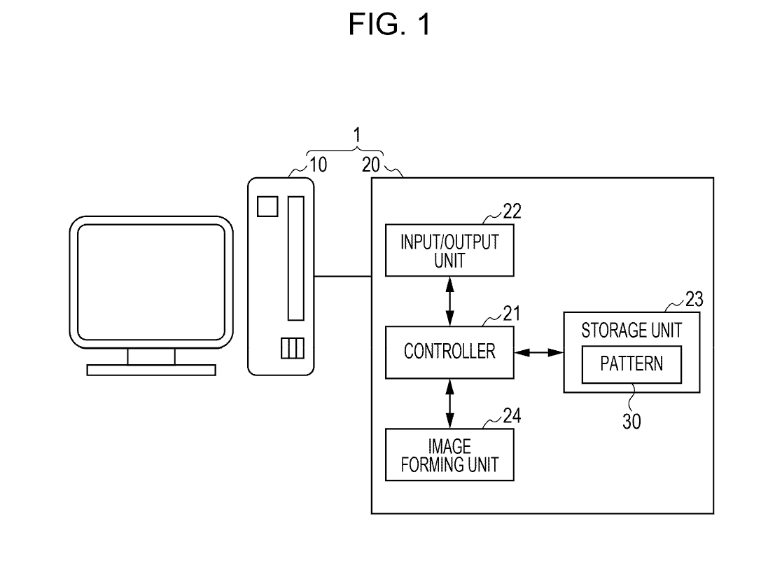

FIG. 1 is a diagram illustrating a configuration of an image forming system 1. The image forming system 1 includes a computer 10 and an image forming apparatus 20. The computer 10 has a function of instructing the image forming apparatus 20 to form an image. The image forming apparatus 20 includes a controller 21, an input/output unit 22, a storage unit 23, and an image forming unit 24. The controller 21 includes a central processing unit (CPU) and a memory. The CPU executes a program stored in the memory to control each unit of the image forming apparatus 20. The input/output unit 22 exchanges data with the computer 10. The storage unit 23, including, e.g., a hard disk drive, stores a pattern 30 into which coordinates in a plane having a predetermined size are coded. The coordinates may be coded in accordance with a method recited in Japanese Patent No. 4215516, for example. The image forming unit 24 forms an image on a recording medium under control of the controller 21. Examples of the recording medium include paper.

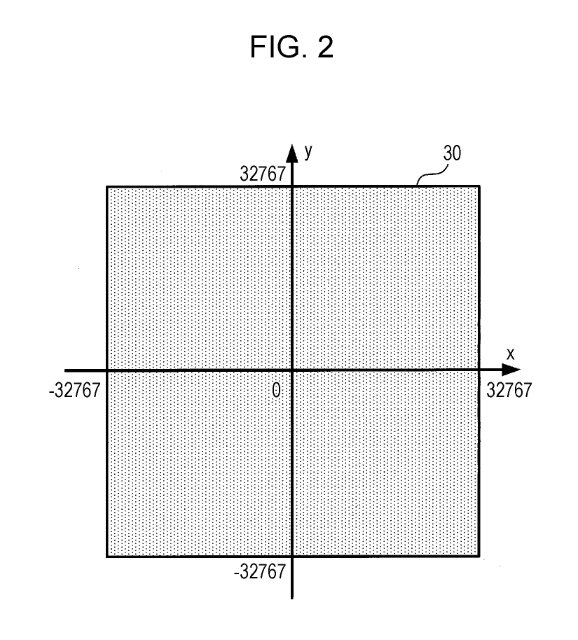

FIG. 2 is a diagram illustrating an example of the pattern 30 stored in the storage unit 23. Fine dots are arranged in the pattern 30. The dot arrangement in the pattern 30 represents coordinates in a plane, with an origin (x, y)=(0, 0) located at the center thereof, having a range defined by an x coordinate ranging from −32767 to 32767 and a y coordinate ranging from −32767 to 32767. In the plane, a unit length of each coordinate axis is 0.1 mm. In this case, one side of the pattern 30 is 65534×0.1=6553.4 mm (about 6.5 m) in length. The image forming apparatus 20 has a function of forming images on recording media of multiple sizes. As the recording media, A4-size and B5-size recording media are generally used in image formation but A0-size recording media may also be used. The A0 size is 841 mm (in width)×1189 mm (in length). The pattern 30 occupies an area that is much larger than the A0 size so that recording media of any size can be handled with the pattern 30. Meanwhile, dimensions of a longer side and a shorter side of a recording medium are herein referred to as length and width, respectively.

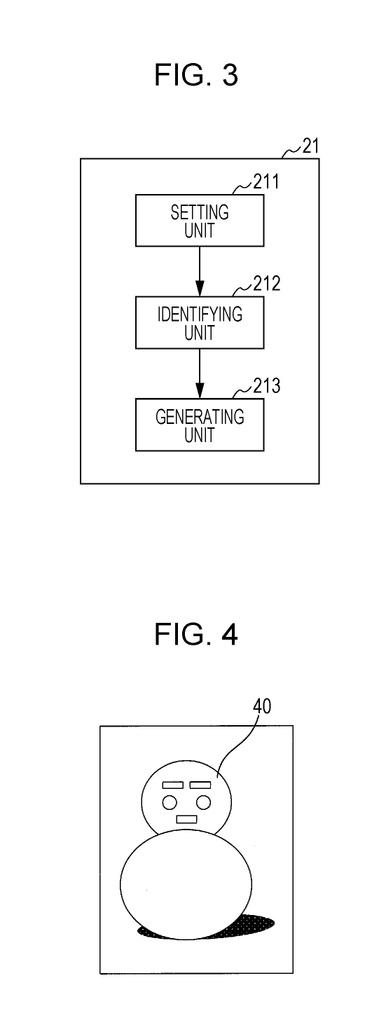

FIG. 3 is a diagram illustrating a functional configuration of the controller 21. The controller 21 functions as a setting unit 211, an identifying unit 212, and a generating unit 213. The setting unit 211 sets a pattern area on a recording medium. The identifying unit 212 identifies a position of the pattern area in a predetermined plane. At this time, the pattern area set by the setting unit 211 is arranged in the plane with a specified position in the pattern area located at a center of the plane. The generating unit 213 generates a pattern into which the position identified by the identifying unit 212 is coded.

The image forming apparatus 20 receives a print instruction from the computer 10. The print instruction includes image data representing an image 40. The image data is specified by a user, for example. The print instruction also includes pattern information that specifies a pattern formation mode selected from an entire area mode and a partial area mode. When the entire area mode is selected, the pattern 30 is formed all over a recording medium. On the other hand, when the partial area mode is selected, the pattern 30 is formed on part of a recording medium where the image 40 is formed. The pattern formation mode is selected by a user, for example.

Once a print instruction is input from the computer 10, the controller 21 acquires the print instruction via the input/output unit 22. The print instruction includes image data representing the image 40 illustrated in FIG. 4, for example. Upon acquiring the print instruction, the controller 21 performs a following process on the basis of the print instruction.

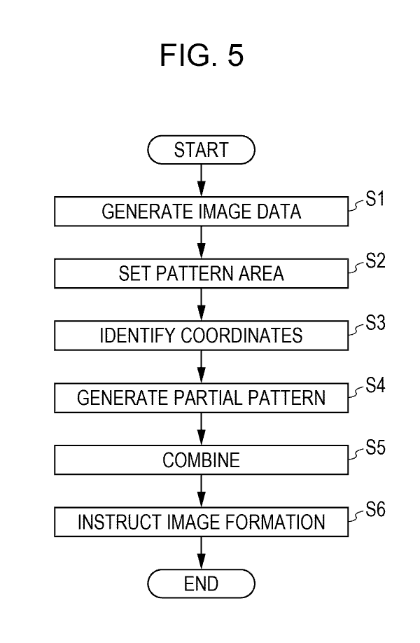

FIG. 5 is a flowchart illustrating the process performed by the controller 21. In step S1, the controller 21 interprets the image data included in the print instruction and generates raster-format image data representing the image 40. The controller 21 also selects a recording medium P having size suitable for forming the image 40 on the basis of size of the image 40 represented by the image data.

In step S2, the controller 21 acquires pattern information from the print instruction. The controller 21 then sets a pattern area 41 (41a, 41b, 41c, and 41d) on the recording medium P having the size selected in step S1 on the basis of the pattern formation mode specified by the acquired pattern information.

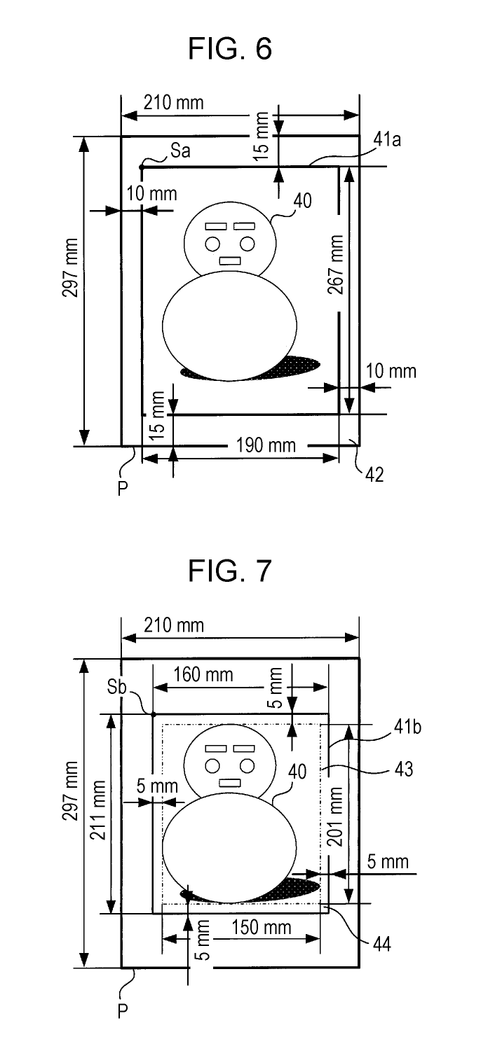

FIG. 6 is a diagram illustrating an example of a pattern area 41a set when the entire area mode is specified. In this case, the controller 21 sets, as the pattern area 41a, an area of the recording medium P excluding margins 42 that have been previously set on the recording medium P. The margins 42 indicate areas of the recording medium P that are not to be used for image formation. For example, when the recording medium P of A4 size (210 mm (in width)×297 mm (in length)) is selected in step S1 and the previously set left and right margins 42 and top and bottom margins 42 are 10 mm wide and 15 mm wide, respectively, the pattern area 41a is 190 mm (in width)×267 mm (in length). More specifically, a horizontal length of the pattern area 41a is determined by subtracting the widths (10 mm×2) of the left and right margins 42 from the horizontal length (210 mm) of the recording medium P. A vertical length of the pattern area 41a is determined by subtracting the widths (15 mm×2) of the top and bottom margins 42 from the vertical length (297 mm) of the recording medium P. In this case, a start point Sa of the pattern area 41a is separated from a left end of the recording medium P by 10 mm and from an upper end thereof by 15 mm. A distance from the left end of the recording medium P to the start point Sa corresponds to the width of the left margin 42. A distance from the upper end of the recording medium P to the start point Sa corresponds to the width of the top margin 42.

FIG. 7 is a diagram illustrating an example of a pattern area 41b set when the partial area mode is specified. In this case, the controller 21 first determines a circumscribed rectangle 43 of the image 40 represented by the image data generated in step S1. The circumscribed rectangle 43 indicates a minimally sized rectangle that encloses the image 40. The controller 21 then sets, as the pattern area 41b, an area resulting from adding previously set widths 44 to the circumscribed rectangle 43. That is, the pattern area 41b corresponds to an enlarged area of the circumscribed rectangle 43. For example, when the circumscribed rectangle 43 of the image 40 is 150 mm (in width)×201 mm (in length) and the previously set widths 44 are 5 mm, the pattern area 41b is 160 mm (in width)×211 mm (in length). More specifically, a horizontal length of the pattern area 41b is determined by adding the left and right widths 44 (5 mm×2) to the horizontal length (150 mm) of the circumscribed rectangle 43. A vertical length of the pattern area 41b is determined by adding the top and bottom widths 44 (5 mm×2) to the vertical length (201 mm) of the circumscribed rectangle 43. In this case, a start point Sb of the pattern area 41b is separated from a left end of the recording medium P by 25 mm and from an upper end thereof by 43 mm. A distance from the left end of the recording medium P to the start point Sb is determined by subtracting the horizontal length (160 mm) of the pattern area 41b from the horizontal length (210 mm) of the recording medium P and then dividing the subtraction result by two. A distance from the upper end of the recording medium P to the start point Sb is determined by subtracting the vertical length (211 mm) of the pattern area 41b from the vertical length (297 mm) of the recording medium P and then dividing the subtraction result by two.

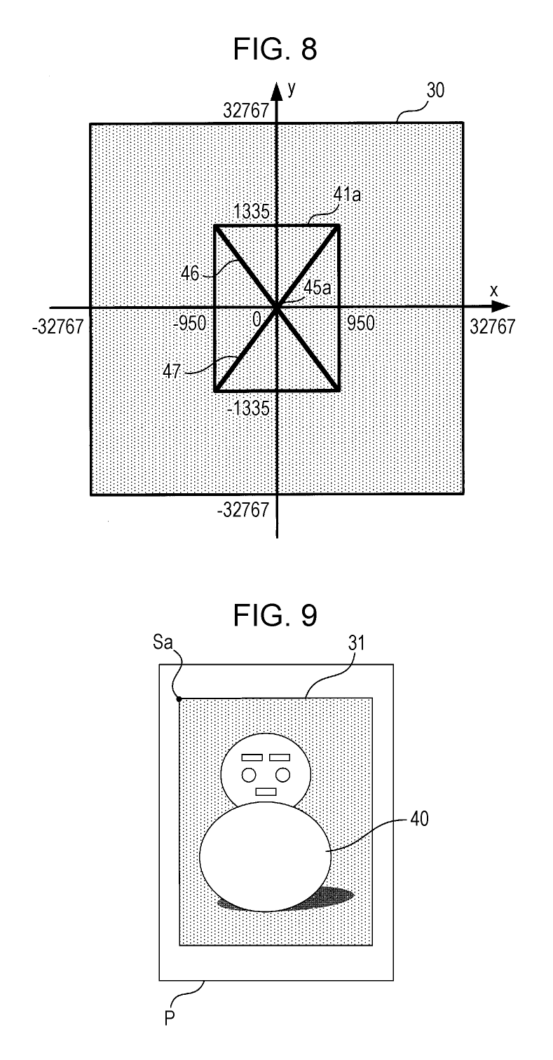

In step S3, the controller 21 identifies coordinates of the pattern area 41 in a plane represented by the pattern 30 on the basis of the pattern 30 stored in the storage unit 23 and the pattern area 41 set in step S2. FIG. 8 is a diagram describing a method for identifying coordinates of the pattern area 41a illustrated in FIG. 6. The controller 21 first determines a center 45a of the pattern area 41a. For example, the controller 21 determines an intersection point of two diagonals 46 and 47 of the pattern area 41a and uses this intersection point as the center 45a. Alternatively, the controller 21 may determine a middle point of the diagonal 46 or 47 of the pattern area 41a and use this middle point as the center 45a. The controller 21 then identifies coordinates of the pattern area 41a in the plane. At this time, the pattern area 41a is arranged in the plane with the center 45a of the pattern area 41a located at the origin (x, y)=(0, 0) of the plane represented by the pattern 30. As described above, the pattern area 41a is 190 mm (in width)×267 mm (in length). Additionally, the unit length of each coordinate axis is 0.1 mm in this plane. In this case, an x-axis-direction length of the pattern area 41a is 190/0.1=1900, whereas a y-axis-direction length of the pattern area 41a is 267/0.1=2670. Accordingly, the coordinates of the pattern area 41a, arranged in the plane in the aforementioned manner, in the plane are represented by an x coordinate ranging from −950 to 950 and a y coordinate ranging from −1335 to 1335.

In step S4, the controller 21 generates a partial pattern 31 into which the coordinates identified in step S3 are coded. Referring to FIG. 8, the x coordinate ranging from −950 to 950 and the y coordinate ranging from −1335 to 1335 are identified as the coordinates of the pattern area 41a. In this case, the controller 21 extracts the partial pattern 31 into which these coordinates are coded from the pattern 30 stored in the storage unit 23.

In step S5, the controller 21 combines the image 40 with the partial pattern 31 on the basis of the image data generated in step S1 and the partial pattern 31 generated in step S4. At this time, the controller 21 arranges the image 40 at a central part of the recording medium P, whereas the controller 21 arranges the partial pattern 31 over the pattern area 41 set in step S2, for example. In this way, the combined image is generated in which the image 40 and the partial pattern 31 are superposed.

In step S6, the controller 21 supplies image data representing the combined image generated in step S5 to the image forming unit 24 and instructs the image forming unit 24 to form the combined image. The image forming unit 24 forms the combined image on the recording medium P on the basis of the image data supplied from the controller 21. At this time, the image forming unit 24 forms the image 40 using color toners, such as of yellow, magenta, cyan, and black. On the other hand, the image forming unit 24 forms the partial pattern 31 using an invisible toner that absorbs infrared light or ultraviolet light. Meanwhile, “invisible” indicates a state in which it is made difficult to visually recognize the partial pattern 31 and whether or not the partial pattern 31 can be actually visually recognized does not matter. FIG. 9 is a diagram illustrating an example of the combined image formed on the recording medium P. In this combined image, the image 40 is formed at a central part of the recording medium P. Additionally, the partial pattern 31 is formed from the start point Sa of the pattern area 41a set in step S2.

Information is written on the recording medium P with an electronic pen (not illustrated). The electronic pen reads the partial pattern 31 formed on the recording medium P and decodes the read partial pattern 31. In this way, coordinates on the recording medium P carrying the information are identified. The electronic pen also records coordinate information representing the identified coordinates. This coordinate information is utilized as digital information representing the information written on the recording medium P.

The present invention should not be limited by the aforementioned exemplary embodiment and may be modified and carried out in following manners. Additionally, following modifications may be used in combination.

### First Modification

The size, the shape, and the position of the pattern area 41 are not limited to the ones described in the exemplary embodiment. For example, the pattern area 41 may be an enlarged area of the image 40. Alternatively, the pattern area 41 may be a background area. Additionally, the pattern area 41 may be an area having a predetermined shape or a predetermined size. That is, the pattern area 41 may be any area as long as the area is set on the recording medium P.

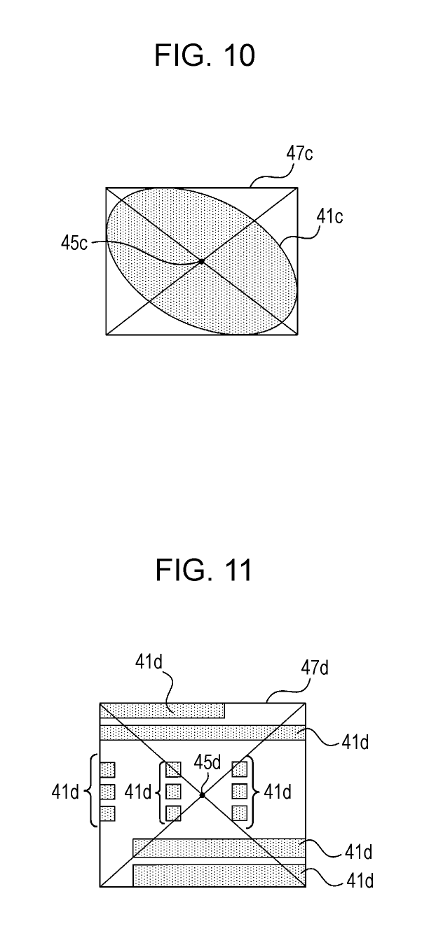

The pattern area 41 may have a non-rectangular shape. FIG. 10 is a diagram illustrating an example of a pattern area 41c according to this modification. The pattern area 41c has an oval shape. In this case, when determining a center 45c of the pattern area 41c, the controller 21 first determines a circumscribed rectangle 47c of the pattern area 41c. The controller 21 then determines a center of this circumscribed rectangle 47c and uses the determined center as the center 45c of the pattern area 41c. Even when the pattern area 41 has the non-rectangular shape in this manner, the pattern area 41 is arranged in the plane based on the center of the plane as in the exemplary embodiment. That is, even when the pattern area 41 has the non-rectangular shape, complicated processing is not needed in generation of the partial pattern 31.

The pattern area 41 does not have to be one area and may be divided into multiple sub-areas. FIG. 11 is a diagram illustrating an example of a pattern area 41d according to this modification. The pattern area 41d is divided into thirteen sub-areas. In this case, when determining a center 45d of the pattern area 41d, the controller 21 first determines a minimally sized rectangle 47d that encloses the whole pattern area 41d. The controller 21 then determines a center of the rectangle 47d and uses the determined center as the center 45d of the pattern area 41d. Even when the pattern area 41 is divided into multiple sub-areas in this manner, the pattern area 41 is arranged in the plane based on the center of the plane as in the exemplary embodiment. That is, even when the pattern area 41 is divided into multiple sub-areas, complicated processing is not needed in generation of the partial pattern 31.

### Second Modification

When identifying coordinates of the pattern area 41, the controller 21 may arrange the pattern area 41 in the plane with a center of the recording medium P located at the center of the plane. In this case, the controller 21 determines the center of the recording medium P selected in step S1. The center of the recording medium P may be determined with the aforementioned method for determining the center of the pattern area 41 or the center of the recording medium P of each size may be previously stored in a memory.

### Third Modification

In the exemplary embodiment, the origin (x, y)=(0, 0) is used as the center of the plane. However, the center of the plane may be located near the origin. That is, the center mentioned herein includes not only an accurate center point but also positions shifted from the center point. The center of the plane may be any position as long as the pattern area 41 does not extend outside the plane when the pattern area 41 is arranged in the plane with the center of the pattern area 41 located at the center of the plane. This is because it is difficult to generate the appropriate partial pattern 31 when the pattern area 41 extends outside the plane. This also applies to the center of the recording medium P having been described above in the second modification.

### Fourth Modification

In the first modification, the center of the circumscribed rectangle of the pattern area 41 is used as the center of the pattern area 41. However, the center of the pattern area 41 is not limited to the center of the circumscribed rectangle of the pattern area 41. For example, a centroid of the pattern area 41 may be used as the center of the pattern area 41.

### Fifth Modification

When identifying the coordinates of the pattern area 41, the controller 21 may arrange the pattern area 41 in the plane with a position other than the center of the pattern area 41 located at the center of the plane. That is, the controller 21 may identify the coordinates of the pattern area 41 in the plane in a state in which the pattern area 41 is arranged in the plane with a specified position in the pattern area 41 located at the center of the plane.

### Sixth Modification

The plane represented by the pattern 30 is not limited to the one having been described in the exemplary embodiment. For example, the pattern 30 may represent a plane defined by an x coordinate ranging from 0 to 65534 and a y coordinate ranging from 0 to 65534. In this case, a center of this plane is represented by coordinates (x, y)=(32767, 32767), for example.

### Seventh Modification

The size of the recording medium P may be selected by a user. In this case, a print instruction includes information indicating the size of the recording medium P selected by the user. Additionally, the image forming apparatus 20 may include an operation unit that receives an operation of the user. In this case, the size of the recording medium P may be selected with this operation unit. Meanwhile, in the exemplary embodiment, the partial pattern 31 is generated in a similar procedure even when the size of the recording medium P differs. Accordingly, for example, even if the size of the recording medium P is changed after a print instruction is issued, a position serving as a reference of the plane does not have to be changed at the time when pattern area 41 is arranged in the plane.

### Eighth Embodiment

Image data may be stored in the storage unit 23 of the image forming apparatus 20. In this case, the controller 21 performs the aforementioned process on the basis of the image data read out from the storage unit 23. The image data may also be stored in another apparatus connected to the image forming apparatus 20. In this case, the controller 21 acquires the image data from the other apparatus and performs the aforementioned process on the basis of the acquired image data. When the image forming apparatus 20 has a scanning function, the image data may be generated by scanning an image. In this case, the controller 21 performs the aforementioned process on the basis of the generated image data.

### Ninth Modification

Although the process illustrated in FIG. 5 is performed by the image forming apparatus 20 in the exemplary embodiment, this process may be performed by the computer 10. In this case, the computer 10 includes a controller having functions similar to those of the controller 21. After generating image data representing a combined image in step S5, the controller sends this image data to the image forming apparatus 20. The image forming apparatus 20 forms the combined image on a recording medium P on the basis of the image data sent from the computer 10.

### Tenth Modification

Although both the image 40 and the partial pattern 31 are formed on the recording medium P in the exemplary embodiment, the partial pattern 31 alone may be formed on the recording medium P. In this case, the controller 21 skips the processing in step S1 and the process proceeds to step S2. In step S2, the controller 21 sets the pattern area 41 on the recording medium P. The controller 21 then performs the processing in steps S3 and S4. Thereafter, the controller 21 skips the processing in step S5 and the process proceeds to step S6. In step S6, the controller 21 supplies the partial pattern 31 generated in step S4 to the image forming unit 24 and instructs the image forming unit 24 to form an image. In this way, the partial pattern 31 alone is formed on the recording medium P. The controller 21 according to this modification functions as a pattern generating apparatus.

### Eleventh Modification

The controller 21 may include an application specific integrated circuit (ASIC). In this case, the functions of the controller 21 may be realized with the ASIC alone or with both the ASIC and the CPU.

### Twelfth Modification

A program realizing the functions of the controller 21 may be supplied to the image forming apparatus 20 after being stored on a computer readable recording medium, such as a magnetic recording medium (a magnetic tape, a magnetic disk (a hard disk drive (HDD) or a flexible disk (FD)), or the like), an optical recording medium (an optical disc (a compact disc (CD) or a digital versatile disk (DVD) or the like), a magneto-optical recording medium, or a semiconductor memory and may be installed in the image forming apparatus 20. Additionally, the program realizing the functions of the controller 21 may be downloaded and installed via a communication line.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A pattern generating apparatus comprising:
a setting unit that sets a pattern area on a recording medium;
an identifying unit that identifies a position of the pattern area in a plane having a predetermined size, the pattern area being arranged in the plane with a specified position in the pattern area located at or substantially at a center of the plane; and
a generating unit that generates a pattern into which the identified position is coded.

2. The pattern generating apparatus according to claim 1, wherein the pattern area is arranged in the plane with a center of the pattern area located at or substantially at the center of the plane.

3. The pattern generating apparatus according to claim 2, wherein the pattern area is arranged in the plane with a center of a circumscribed rectangle of the pattern area located at or substantially at the center of the plane.

4. A pattern generating apparatus comprising:
a setting unit that sets a pattern area on a recording medium;
an identifying unit that identifies a position of the pattern area in a plane having a predetermined size, the pattern area being arranged in the plane with a center of the recording medium located at or substantially at a center of the plane; and
a generating unit that generates a pattern into which the identified position is coded.

5. The pattern generating apparatus according to claim 1, wherein the setting unit sets, as the pattern area, an area of the recording medium excluding a margin previously set on the recording medium.

6. The pattern generating apparatus according to claim 4, wherein the setting unit sets, as the pattern area, an area of the recording medium excluding a margin previously set on the recording medium.

7. The pattern generating apparatus according to claim 1, wherein the setting unit sets, as the pattern area, an enlarged area of a circumscribed rectangle of an image to be formed on the recording medium.

8. The pattern generating apparatus according to claim 4, wherein the setting unit sets, as the pattern area, an enlarged area of a circumscribed rectangle of an image to be formed on the recording medium.

9. The pattern generating apparatus according to claim 1, wherein a plurality of dots are arranged in the pattern.

10. The pattern generating apparatus according to claim 4, wherein a plurality of dots are arranged in the pattern.

11. An image forming apparatus comprising:
the pattern generating apparatus according to claim 1;
an acquiring unit that acquires image data representing an image; and
an image forming unit that forms the image represented by the acquired image data and the pattern generated by the generating unit on the recording medium.

12. An image forming apparatus comprising:
the pattern generating apparatus according to claim 4;
an acquiring unit that acquires image data representing an image; and
an image forming unit that forms the image represented by the acquired image data and the pattern generated by the generating unit on the recording medium.

13. The image forming apparatus according to claim 11, wherein the image forming unit forms the pattern by using a toner that absorbs infrared light or ultraviolet light.

14. The image forming apparatus according to claim 12, wherein the image forming unit forms the pattern by using a toner that absorbs infrared light or ultraviolet light.

15. A non-transitory computer readable medium storing a program causing a computer to execute a process for generating a pattern, the process comprising:
setting a pattern area on a recording medium;
identifying a position of the pattern area in a plane having a predetermined size, the pattern area being arranged in the plane with a specified position in the pattern area located at or substantially at a center of the plane; and
generating a pattern into which the identified position is coded.

16. A non-transitory computer readable medium storing a program causing a computer to execute a process for generating a pattern, the process comprising:
setting a pattern area on a recording medium;
identifying a position of the pattern area in a plane having a predetermined size, the pattern area being arranged in the plane with a center of the recording medium located at or substantially at a center of the plane; and
generating a pattern into which the identified position is coded.
